(19) United States
(12) Patent Application Publication
(10) Pub. No.: US 2006/0171139 A1
(43) Pub. Date: Aug. 3, 2006

(54) Backlight assembly and liquid crystal display device having the same

(75) Inventors: Joong-Hyun Kim, Suwon-si (KR); In-Sun Hwang, Suwon-si (KR)

Correspondence Address: David W. Heid;MacPHERSON KWOK CHEN & HEID LLP, Suite 226, 1762 Technology Drive, San Jose, CA, 95110, US

(73) Assignee: Samsung Electronics Co., Ltd., Suwon-si (KR)

(21) Appl. No.: 11/272,160

(22) Filed: Nov. 10, 2005

(30) Foreign Application Priority Data
Jan. 28, 2005 (KR) 2005-8101

(51) Int. Cl. G01D 11/28; F21V 5/02; F21V 31/00

(52) U.S. Cl. 362/29; 362/223; 362/267; 362/260; 362/330; 362/339

(57) ABSTRACT

A liquid crystal display device includes a backlight assembly and an LCD device associated with the backlight assembly. The backlight assembly includes a flat fluorescent lamp, a brightness enhancement member and a light diffusing member. The flat fluorescent lamp has a plurality of discharge spaces which generate light. The brightness enhancement member is on the flat fluorescent lamp, and guides the light generated from the flat fluorescent lamp toward a viewer's side of the liquid crystal display device. The diffusion member is on the brightness enhancement member, and diffuses the guided light.

### CROSS-REFERENCE TO RELATED APPLICATION

The present application claims priority from Korean Patent Application No. 2005-008101, filed on Jan. 28, 2005, the disclosure of which is hereby incorporated herein by reference in its entirety.

### BACKGROUND OF THE INVENTION

1. Field of the Invention

The present invention relates to a backlight assembly and a liquid crystal display ( LCD) device using the backlight assembly. More particularly, the present invention relates to a backlight assembly having reduced thickness and increased luminance, and an LCD device using the backlight assembly.

2. Description of the Related Art

An LCD device displays an image using a liquid crystal that has optical characteristics such as anisotropy of refractivity and electrical characteristics such as anisotropy of dielectric constant. LCD devices have various characteristics such as thinner thickness, lower driving voltage, and lower power consumption, than other display devices such as a cathode ray tube (CRT) device, and plasma display panel (PDP) device. Therefore, LCD devices are used in notebook computers, monitors, and television receivers.

The LCD device is a non-emissive type display device and includes a backlight assembly to supply an LCD panel of the LCD device with a light.

Prior art LCD devices typically include a cold cathode fluorescent lamp CCFL which has thin cylindrical shape extended in a predetermined direction. A large LCD device includes a plurality of CCFLs. When the number of the CCFLs is increased, the manufacturing cost of the LCD device is also increased, and optical characteristics such as luminance uniformity are inferior.

Flat fluorescent lamps have been developed to overcome disadvantages of CCFLs. The flat fluorescent lamp includes a lamp body having a plurality of discharge spaces and an external electrode through which a discharge voltage is applied to the lamp body. An inverter applies the discharge voltage to the external electrode to form a plasma discharge in the discharge spaces. Ultraviolet light generated in the discharge spaces is converted into a visible light by a fluorescent layer formed on an inner surface of the lamp body.

The flat fluorescent lamp is divided into a plurality of spaced apart discharge spaces each of which produces that a shadow line. In order to prevent the shadow line and provide a more uniform luminance of the light generated from the backlight assembly, a diffusion plate is used with the backlight assembly. The diffusion plate is spaced apart from the flat fluorescent lamp by a predetermined distance, which is typically more than about 12 mm. When the distance between the diffusion plate and the flat fluorescent lamp increases, a luminance of the flat fluorescent lamp is decreased and the thickness of the flat fluorescent lamp is increased.

### SUMMARY OF THE INVENTION

The present invention provides a backlight assembly capable of decreasing thickness and increasing luminance.

The present invention also provides an LCD device having the above backlight assembly.

A backlight assembly in accordance with an exemplary embodiment of the present invention includes a flat fluorescent lamp, a brightness enhancement member and a diffusion member. The flat fluorescent lamp has a plurality of discharge spaces to generate a light. The brightness enhancement member is on the flat fluorescent lamp, and guides the light generated from the flat fluorescent lamp toward a viewer's side. The diffusion member is on the brightness enhancement member, and diffuses the guided light.

A liquid crystal display device in accordance with an exemplary embodiment of the present invention includes a backlight assembly and a liquid crystal display panel. The backlight assembly includes a flat fluorescent lamp, a brightness enhancement member and a diffusion member. The flat fluorescent lamp has a plurality of discharge spaces to generate a light. The brightness enhancement member is on the flat fluorescent lamp, and guides the light generated from the flat fluorescent lamp toward a viewer's side. The diffusion member is on the brightness enhancement member, and diffuses the guided light. The liquid crystal display panel is on the diffusion member. The liquid crystal display panel displays an image using the diffused light.

According to the present invention, the brightness enhancement member is interposed between the flat fluorescent lamp and the diffusion member so that a thickness of the backlight assembly is decreased, and a luminance of the backlight assembly is improved.

### BRIEF DESCRIPTION OF THE DRAWINGS

The above and other advantages of the present invention will become apparent in light of the following description of the exemplary embodiments thereof with reference to the accompanying drawings, in which:

FIG. 1 is an exploded perspective view showing a backlight assembly in accordance with an exemplary embodiment of the present invention;

FIG. 2 is a cross-sectional view taken along a line 2-2 of FIG. 1 showing backlight assembly 100 in an assembled state;

FIG. 3A is an enlarged cross-sectional view showing a portion of the brightness enhancement member 300 shown in FIG. 2;

FIG. 3B is an enlarged cross-sectional view of a portion of an alternative brightness enhancement member;

FIG. 4 is a graph showing a relationship between a luminance ratio of a bright region to a dark region, as a function of the distance d between the flat fluorescent lamp 200 and a prism pattern 310 of the brightness enhancement film 300;

FIG. 5 is a cross-sectional view showing another exemplary brightness enhancement film suitable for use in a backlight assembly such as that shown in FIG. 2;

FIG. 6 is a cross-sectional view showing a backlight assembly in accordance with another exemplary embodiment of the present invention;

FIG. 7 is a perspective view showing the flat fluorescent lamp shown in FIG. 1;

FIG. 8 is a cross-sectional view taken along a line 8-8 shown in FIG. 7; and

FIG. 9 is a perspective view showing an LCD device in accordance with an exemplary embodiment of the present invention.

### DESCRIPTION OF THE EMBODIMENTS

It should be understood that the exemplary embodiments of the present invention described below may be varied modified in many different ways without departing from the inventive principles disclosed herein, and the scope of the present invention is therefore not limited to these particular embodiments. Rather, these embodiments are provided so that this disclosure will be through and complete, and will fully convey the concept of the invention to those skilled in the art by way of example and not of limitation.

Hereinafter, the present invention will be described in detail with reference to the accompanying drawings.

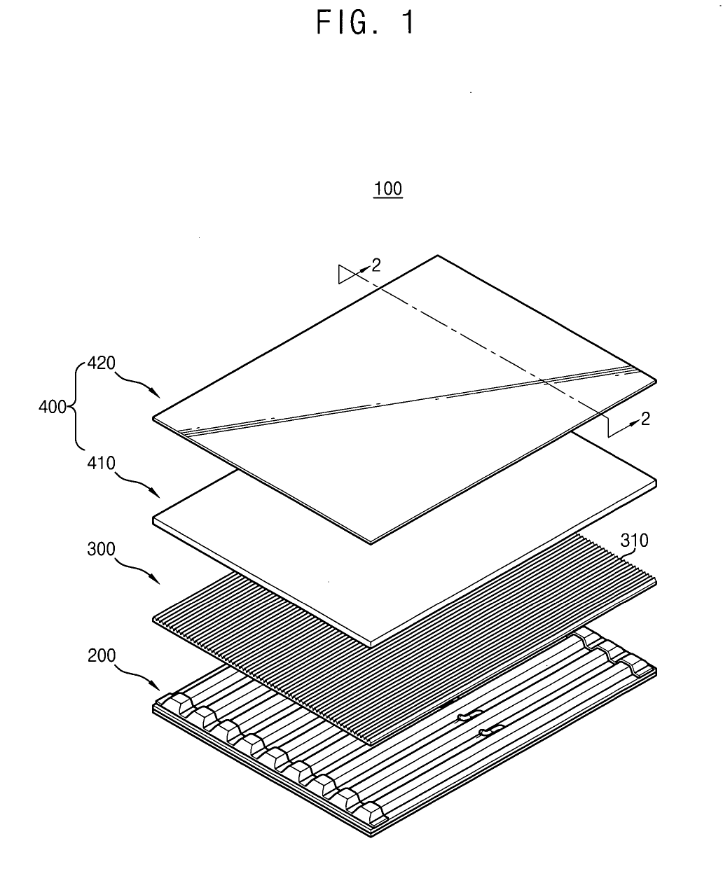

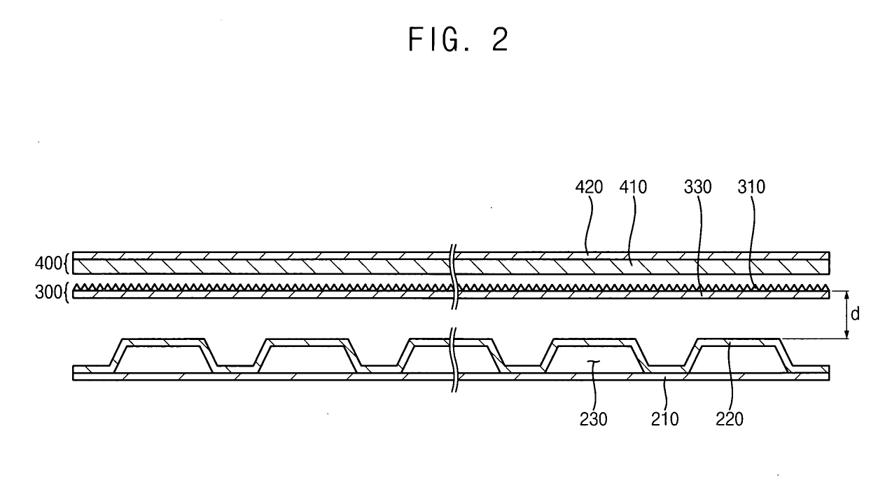

FIG. 1 is an exploded perspective view showing a backlight assembly in accordance with an exemplary embodiment of the present invention. FIG. 2 is a cross-sectional view taken along a line 2-2 of FIG. 1.

Referring to FIGS. 1 and 2, the backlight assembly 100 includes a flat fluorescent lamp 200, a brightness enhancement member 300 and a diffusion unit 400.

The flat fluorescent lamp 200 includes a plurality of discharge spaces 230, and generates a light. The flat fluorescent lamp 200 has a flat quadrangular shape. The flat fluorescent lamp 200 generates a plasma discharge based on a discharge voltage that is provided from an inverter (not shown). An ultraviolet light generated by the plasma discharge is converted into a visible light, and the visible light is emitted from the discharge spaces 230. An area of the flat fluorescent lamp 200 is large to generate the visible light in a planar shape. As shown in FIG. 2, flat fluorescent lamp 200 includes a first substrate 210 and a second substrate 220. The second substrate 220 is combined with the first substrate 210 to form the discharge spaces 230.

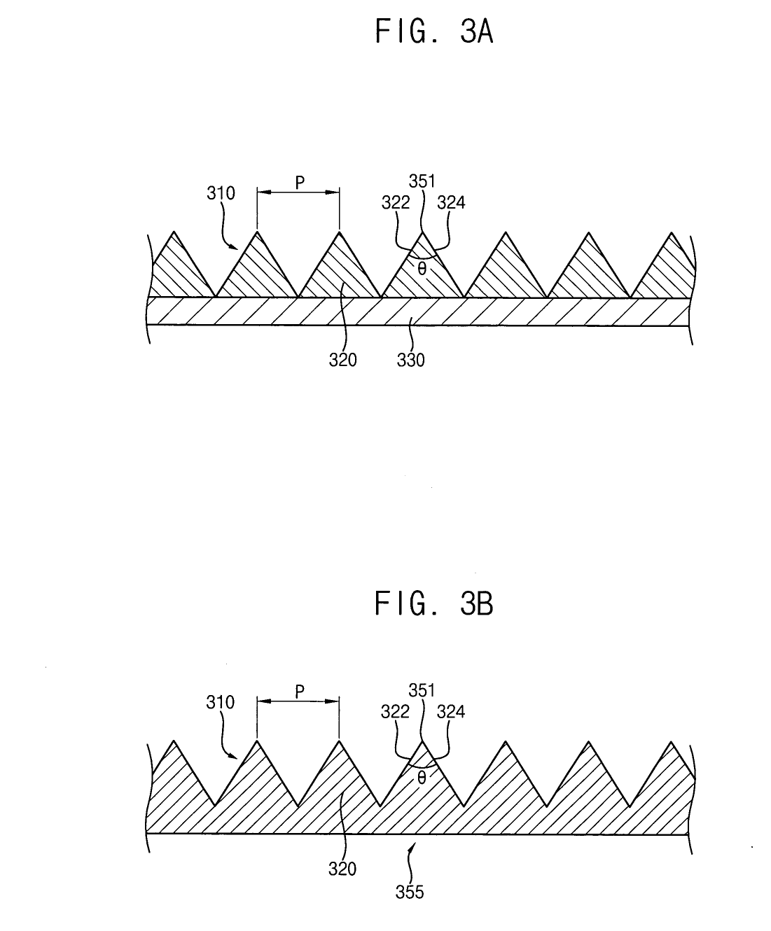

As shown in FIGS. 1 and 2, brightness enhancement member 300 is positioned above flat fluorescent lamp 200, brightness enhancement member 300 increases a luminance of the visible light generated from the flat fluorescent lamp 200. As shown in FIGS. 3A and 3B, brightness enhancement member 300 includes a prism pattern 310 that has a plurality of prisms 320 which are adjacent to one another and which are positioned on transparent film 330. Alternatively, the brightness enhancement member 300 may be a unitary film or sheet which includes the prism pattern 310. Suitable materials for making prism pattern 310 include, for example, polycarbonate (PC), polyethyleneterephthalate (PET), etc. FIG. 3B illustrates a unitary embodiment of brightness enhancement member 355. Member 355 is constructed of the same material as prisms 320. The peaks of prisms 320 point toward the underside of diffusion unit 400. The visible light generated from the flat fluorescent lamp 200 radiates toward brightness enhancement member 300 and is refracted towards a viewer's side of the backlight assembly 100. Brightness enhancement member 300 provides increased luminance on the viewer's side. The viewer's side is in a direction substantially perpendicular to an upper surface of the backlight assembly 100. The brightness enhancement member 300 also decreases a shadow line which would otherwise appear to the viewer because of the space between adjacent discharge spaces 230. Alternatively, the prism pattern 310 may be formed only on the discharge spaces 230.

The brightness enhancement member 300 is on the flat fluorescent lamp 200 and spaced apart from the flat fluorescent lamp 200 by a predetermined distance ‘d’ so that a luminance on each of the discharge spaces 230 and a luminance between the adjacent discharge spaces 230 are substantially same. In this exemplary embodiment, the distance ‘d’ between the brightness enhancement member 300 and the flat fluorescent lamp 200 is no more than about 10 mm. For example, the distance ‘d’ between the brightness enhancement member 300 and the flat fluorescent lamp 200 is about 3 mm to about 4 mm. Therefore, the brightness enhancement member 300 is adjacent to the flat fluorescent lamp 200 so that the distance ‘d’ between the brightness enhancement member 300 and the flat fluorescent lamp 200 is decreased, thereby decreasing a thickness of the backlight assembly 100.

As shown in FIG. 3A, brightness enhancement member 300 includes a transparent film 330 so that the visible light may pass through the brightness enhancement member 300. Examples of suitable materials for layer 330 are polycarbonate (PC), polyethyleneterephthalate (PET), etc. The prism pattern 310 may be formed through a stamping process, an extrusion molding process, or a deposition process.

The diffusion unit 400 is provided above the brightness enhancement member 300 to diffuse the visible light that passes through the brightness enhancement member 300, thereby providing a more uniform luminance.

In this exemplary embodiment, the diffusion unit 400 includes a diffusion plate 410 and at least one diffusion sheet 420 on the diffusion plate 410.

The diffusion plate 410 is rectangular and of a predetermined thickness. The thickness of the diffusion plate 410 is about 1 mm to about 3 mm. The diffusion plate 410 includes a transparent material and a diffusing agent. For example, the diffusion plate 410 contains polymethylmethacrylate (PMMA).

The diffusion sheet 420 is a thin film and has thinner thickness than the diffusion plate 410. In this exemplary embodiment, the thickness of the diffusion sheet 420 is about 50 μm to about 300 μm. A plurality of beads is coated on both sides of the diffusion sheet 420 to diffuse the visible light.

Alternatively, the diffusion unit 400 may only include the diffusion plate 410 or the diffusion sheet 420.

The backlight assembly 100 may further include a brightness enhancement sheet (not shown) on the diffusion unit 400. The brightness enhancement sheet (not shown) may be a dual brightness enhancement film (DBEF) manufactured by 3M company.

FIG. 3A is an expanded cross-sectional view showing the brightness enhancement member shown in FIG. 2.

Referring to FIGS. 2 and 3A, the brightness enhancement member 300 includes a transparent film 330 and the prism pattern 310 on the transparent film 330.

The transparent film 330 is comprised of a transparent material so that the visible light may pass through the transparent film 330. The transparent film 330 has a thin thickness of about 50 μm to about 300 μm.

The prism pattern 310 is formed on a surface of the transparent film 330, which faces the diffusion unit 400. The prism pattern 310 contains the transparent material. The prism pattern 310 has triangular prisms 320 that are adjacent to each other.

Each of the prisms 320 has a first surface 322 and a second surface 324 that meet at peak 350. First and second surfaces 322 and 324 slant toward an upper surface of the transparent film 330. An interior angle θ formed between the first and second surfaces 322 and 324 may be from about 60° to about 120°. The pitch between adjacent peaks, indicated in FIGS. 3A and 3B by the letter P, of prisms 320 is about 10 μm to about 100 μm.

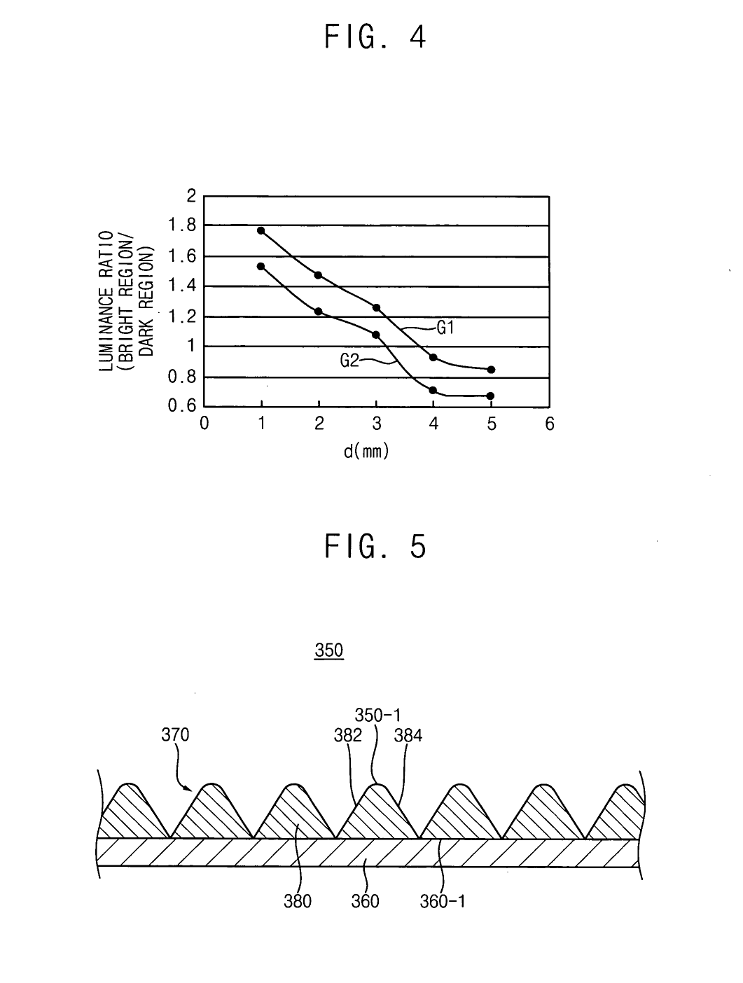

FIG. 4 is a graph showing the relationship between a luminance ratio of a bright region to a dark region, and a distance between the flat fluorescent lamp and a prism pattern of the brightness enhancement member. The bright region is measured on the peaks of each of the discharge spaces 230, and the dark region is between the adjacent discharge spaces 230. In the graph curve G1 represents the results of a prisms having an interior angle of about 90°, and a pitch of the prisms P of about 50 μm. Curve G2 shows the results for prisms having an interior angle of about 68°, and a pitch P of about 50 μm.

Referring to FIG. 4, when the distance ‘d’ between the prism pattern 310 of the brightness enhancement member 300 and the flat fluorescent lamp 200 changes, the luminance ratio of the bright region and the dark region also changes. When the distance ‘d’ is increased, the luminance ratio is decreased.

When the luminance ratio is 1, the luminance uniformity is maximized. In the graph curve G1, when the luminance ratio is about 1, the distance ‘d’ is about 3 mm to about 4 mm. In graph curve G2, when the luminance ratio is about 1, the distance ‘d’ is about 3 mm that is shorter than that of the graph 1 G1. That is, when the interior angle, the pitch and the distance ‘d’ are about 90°, about 50 μm and between about 3 mm to about 4 mm respectively, the luminance uniformity is maximized. In addition, when the interior angle, the pitch and the distance ‘d’ are about 68°, about 50 μm and about 3 mm respectively, the luminance uniformity is maximized.

FIG. 5 is a cross-sectional view showing another exemplary brightness enhancement member suitable for use with backlight assembly of the type shown in FIG. 2. The brightness enhancement member 350 of FIG. 5 is similar to the embodiment in FIG. 3A except for the peaks of the prisms.

Referring to FIG. 5, the brightness enhancement member 350 includes a transparent film 360 and a prism pattern 370 on the transparent film 360.

The prism pattern 370 includes a plurality of triangular prisms 380 that are adjacent to each other. Each of the prisms 380 includes a first surface 382 and a second surface 384 that converge at peak 350-1 and extend to the substrate 360. The first and second surfaces 382 and 384 slant toward an upper surface 360-1 of the transparent film 360. Peak 350-1 is rounded so that prisms 380 are not deformed by the diffusion unit 400.

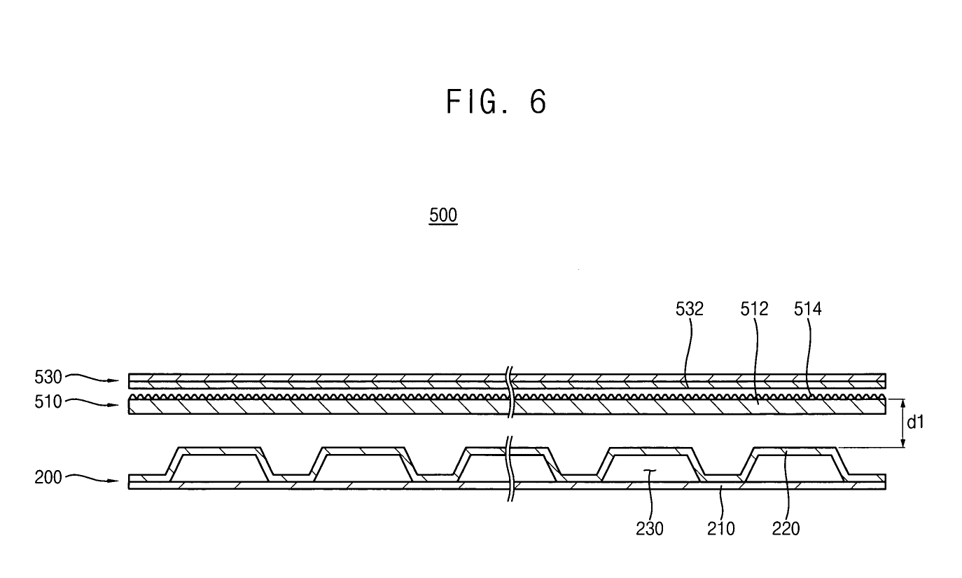

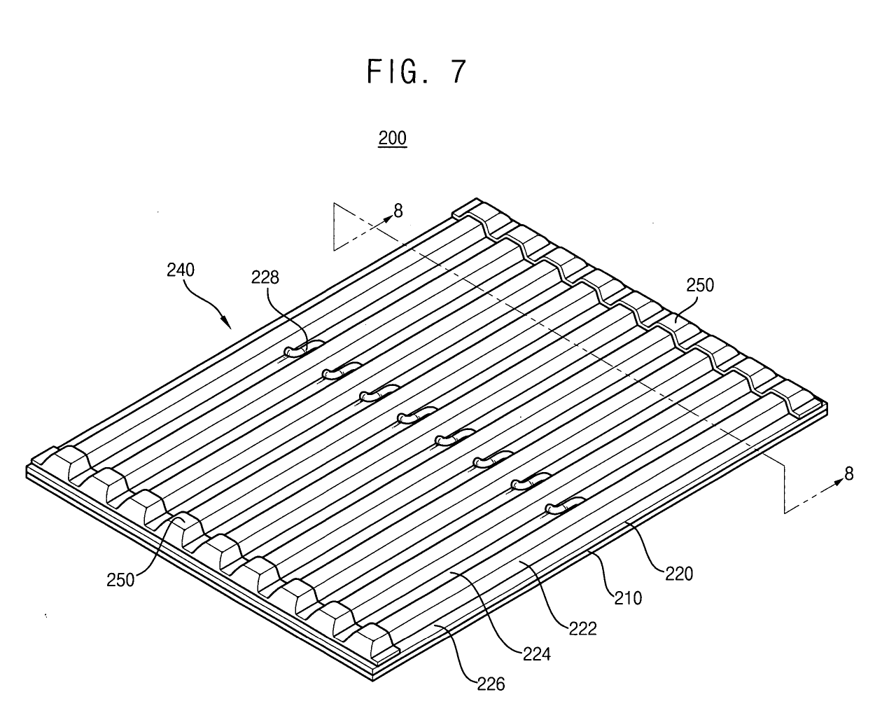

FIG. 6 is a cross-sectional view showing a backlight assembly in accordance with another exemplary embodiment of the present invention. Flat fluorescent lamp 200 of the backlight assembly of FIG. 6 is same as in FIG. 2. Thus, the same reference numerals will be used to refer to the same or like parts as those described in FIG. 2 and any further explanation concerning the above elements will be omitted.

Referring to FIG. 6, the backlight assembly 500 includes a flat fluorescent lamp 200, a brightness enhancement member 510 and a diffusion unit 530.

The brightness enhancement member 510 is positioned above flat fluorescent lamp 200 and spaced apart from the flat fluorescent lamp 200 by a predetermined distance ‘d1. The brightness enhancement member 510 includes a transparent plate 512 and a prism pattern 514 formed on the transparent plate 512.

The transparent plate 512 contains a transparent material so that a visible light that is generated from the flat fluorescent lamp 200 passes through the transparent plate 512. The transparent plate 512 has a predetermined thickness sufficient to prevent transparent plate 512 from becoming deformed during backlight operation. For example, a thickness of the transparent plate 512 is from about 1 mm to about 3 mm.

The prism pattern 514 is formed on an upper surface of the transparent plate 512, which faces the diffusion unit 530. The prism pattern 514 contains the transparent material and has a plurality of triangular prisms that are adjacent to each other. The prism pattern of FIG. 6 may be like those shown in FIG. 3A, FIG. 3B or 5. Thus, any further explanation concerning the prism pattern will be omitted.

The distance ‘d1 between the brightness enhancement member 510 and the flat fluorescent lamp 200 is adjusted so that a bright region of the brightness enhancement member 510 has substantially same luminance as a dark region of the brightness enhancement member 510. In this exemplary embodiment, the distance ‘d’ between the brightness enhancement member 510 and the flat fluorescent lamp 200 is no more than about 10 mm. For example, the distance ‘d1 between the brightness enhancement member 510 and the flat fluorescent lamp 200 is from about 3 mm to about 4 mm.

The diffusion unit 530 is on the brightness enhancement member 510 to diffuse the visible light that passes through the brightness enhancement member 510, thereby uniformizing the luminance of the visible light. The diffusion unit 530 includes at least one diffusion sheet 532 on the diffusion plate 530. In this exemplary embodiment, the diffusion unit 530 includes two diffusion sheets 532. Alternatively, the diffusion unit 530 may include three diffusion sheets 532.

Each of the diffusion sheets 532 has a thickness which is less than the thickness than the brightness enhancement member 510. In this exemplary embodiment, the thickness of each of the diffusion sheets 532 is from about 50 μm to about 300 μm. A plurality of beads (not shown) is coated on both sides of each of the diffusion sheets 532 to diffuse the visible light.

The diffusion unit 530 may include a diffusion plate (not shown) that is thicker than each of the diffusion sheets 532. In addition, the backlight assembly 500 may further include a brightness enhancement sheet (not shown) on the diffusion unit 530. For example, the brightness enhancement sheet (not shown) may be a dual brightness enhancement film (DBEF) manufactured by 3M Company.

Table 1 represents luminance of a viewer's side of the backlight assembly several combinations of brightness enhancement members and diffusion units. The brightness enhancement member, a diffusion plate and diffusion sheets are indicated by PS, DP and DS, respectively.

TABLE 1

| No. of Backlight Assembly | Structure | Luminance (nt) |
|---|---|---|
| 1 | DP | 4494 |
| 2 | DP + DS | 5507 |
| 3 | PS + DP | 4671 |
| 4 | PS + DS + DS | 7533 |
| 5 | PS + DS + DS + DS | 6923 |

Referring to Table 1, the luminance of each backlight assembly of No. 3, 4 and 5 is greater than each backlight assembly of No. 1 and 2. The backlight assembly having the brightness enhancement member PS has greater luminance than the backlight assembly without the brightness enhancement member PS. In addition, when the number of the diffusion sheets is increased, the luminance of the backlight assembly is also increased. When the backlight assembly includes the brightness enhancement member, the luminance is uniformized by a prism pattern of the brightness enhancement member so that an amount of the light that is guided toward a display panel is increased. Therefore, the efficiency of the visible light generated from the flat fluorescent lamp is increased.

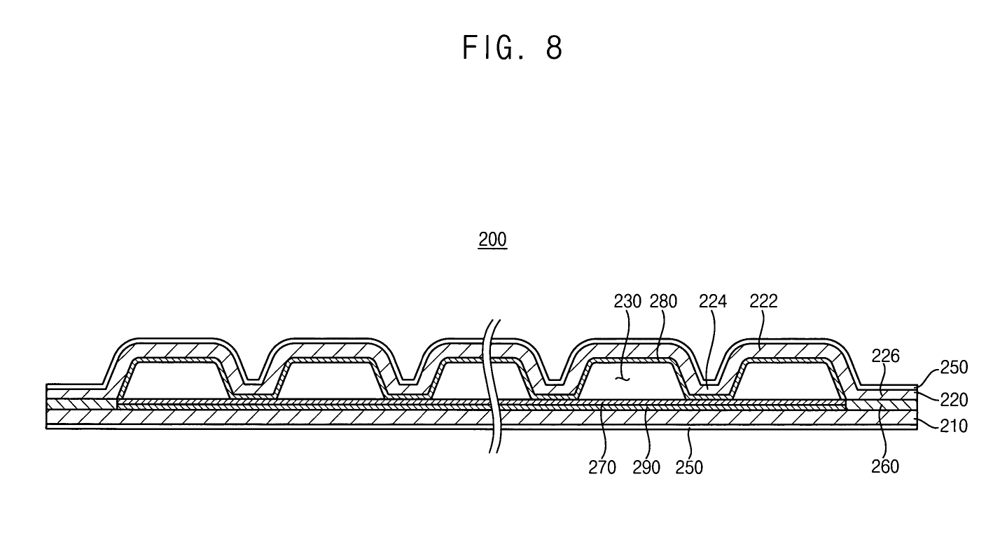

FIG. 7 is a perspective view showing the flat fluorescent lamp shown in FIG. 1. FIG. 8 is a cross-sectional view taken along a line 8-8 shown in FIG. 7.

Referring to FIGS. 7 and 8, the flat fluorescent lamp 200 includes a lamp body 240 and an external electrode 250. The flat fluorescent lamp 200 may include a plurality of external electrodes 250. The lamp body 240 includes a plurality of discharge spaces 230 that are spaced apart from one another. Each of the external electrodes 250 is on an end portion of the lamp body 240, and crosses the discharge spaces 230.

The lamp body 240 includes a first substrate 210 and a second substrate 220. The second substrate 220 is combined with the first substrate 210 to form the discharge spaces 230.

The first substrate 210 has a quadrangular plate shape. In this exemplary embodiment, the first substrate 210 includes glass that contains UV-proof material.

The second substrate 220 is formed through a framing process. The second substrate 220 contains a transparent material so that the visible light may pass through the second substrate 220. For example, the second substrate 220 includes glass that contains the UV-proof material.

In the framing process, a glass plate may be heated and pressed to form the second substrate 220. Alternatively, the second substrate 220 may be formed through a blow framing process. In the blow framing process, the glass plate is heated and compressed by an air to form the second substrate 220.

The second substrate 220 has a plurality of discharge space portions 222, a plurality of space dividing portions 224 and a sealing portion 226 to form the discharge spaces 230. The discharge space portions 222 are spaced apart from the first substrate 210 to form the discharge spaces 230. The space dividing portions 224 are between the discharge space portions 222, and make contact with the first substrate 210 to define sides of the discharge spaces 230. The sealing portion 226 is adjacent to sides of the second substrate 220 so that the first substrate 210 is combined with the second substrate 220. That is, the sealing portion 226 surrounds the discharge space portions 222 and the space dividing portions 224. The sealing portion 226 makes contact with a peripheral portion of the first substrate 210. The discharge space portions 222 correspond to a dark region, and the space dividing portions 224 correspond to a bright region. The brightness enhancement member 300 that has a prism pattern 310 is on the flat fluorescent lamp 200 so that the dark region has substantially same luminance as the bright region. In this exemplary embodiment, the prism pattern 310 is on an entire surface of the brightness enhancement member 300. Alternatively, the prism pattern 310 may only correspond to the space dividing portions 224.

A cross-section of the second substrate 220 includes a plurality of trapezoidal shapes that are connected to one another. The trapezoidal shapes have rounded corners, and arranged in substantially parallel. Alternatively, the cross-section of the second substrate 220 may have a semicircular shape, a quadrangular shape, or a polygonal shape.

A connecting passage 228 is formed on the second substrate 220 to connect the discharge spaces 230 adjacent to each other. In this exemplary embodiment, at least one connecting passage 228 is formed on each of the space dividing portions 224. Each of the connecting passages 228 is spaced apart from the first substrate 210 by a predetermined distance. The connecting passages 228 may be formed through the framing process for forming the second substrate 220. The discharge gas that is injected into one of the discharge spaces 230 may pass through each of the connecting passages 228 so that pressure in the discharge spaces 230 is substantially equal to one another. Each of the connecting passages 228 has various shapes such as ‘S’ shape. When each of the connecting passages 228 has the ‘S’ shape, a path length between the adjacent discharge spaces 230 is increased so that a current formed by the discharge voltage uniformly flows through the discharge spaces 230.

An adhesive 260 such as a frit is interposed between the first and second substrates 210 and 220 to combine the first substrate 210 with the second substrate 220. The frit is a mixture of glass and metal, and the melting point of the frit is lower than that of pure glass. That is, the adhesive 260 is prepared on the sealing portion 226 of the first and second substrates 210 and 220, and the adhesive 260 is fired and solidified. The adhesive 260 is fired at a temperature of about 400° C. to about 600° C.

The space dividing portions 224 of the second substrate 220 are combined with the first substrate 210 by a pressure difference between the discharge spaces 230 and outside of the flat fluorescent lamp 200. In particular, the first substrate 210 is combined with the second substrate 220, and an air between the first and second substrates 210 and 220 is discharged so that the discharge spaces 230 are evacuated. A discharge gas is injected into the evacuated discharge spaces 230. For example, the discharge gas contains mercury (Hg), neon (Ne), Argon (Ar), etc. In this exemplary embodiment, a pressure of the discharge gas in the discharge spaces 230 is about 50 Torr to 70 Torr, and an atmospheric pressure of outside of the flat fluorescent lamp 200 is about 760 Torr, thereby forming the pressure difference. Therefore, the space dividing portions 224 are combined with the first substrate 210.

The lamp body 240 further includes a first fluorescent layer 270 and a second fluorescent layer 280. The first fluorescent layer 270 is in the discharge spaces 230 on the first substrate 210. The second fluorescent layer 280 is in the discharge spaces 230 on the second substrate 220. When the ultraviolet light generated by the plasma discharge is irradiated onto the first and second fluorescent layers 270 and 280, excitons are generated in the first and second fluorescent layers 270 and 280. When an energy level of the excitons decreases, the first and second fluorescent layers 270 and 280 emit the visible light.

The lamp body 240 further includes a reflective layer 290 interposed between the first substrate 210 and the first fluorescent layer 270. A portion of the visible light is reflected from the reflective layer 290 toward the second substrate 220 to prevent light leakage of the visible light through the first substrate 210. In this exemplary embodiment, the reflective layer 290 comprises a metal oxide such as aluminum oxide (Al₂O₃) or barium sulfate (BaSO₄) to increase a light reflectivity of the reflective layer 290 and a color reproducibility of a display device having the flat fluorescent lamp 200.

The first fluorescent layer 270 and the reflective layer 290 may be formed on the first substrate 210, and the second fluorescent layer 280 may be formed on the second substrate 220 through a spray coating method. In this exemplary embodiment, the first fluorescent layer 270 and the reflective layer 290 are formed on the upper surface of the first substrate 210 surrounded by the sealing portion 226, and the second fluorescent layer 280 is formed on the lower surface of the second substrate 220 surrounded by the sealing portion 226. Alternatively, the first and second fluorescent layers 270 and 280 and the reflective layer 290 may not be formed between the space dividing portions 224 and the first substrate 210.

The lamp body 240 may further include a protective layer (not shown) between the first substrate 210 and the reflective layer 290 and/or between the second substrate 220 and the second fluorescent layer 280. The protecting layer (not shown) prevents a chemical reaction between mercury (Hg) in the discharge gas and the first or second substrate 210 or 220 to prevent a loss of the mercury and a black spot on the inner surface of the lamp body 240.

Each of the external electrodes 250 is on the end portion of the lamp body 240 so that each of the external electrodes 250 crosses the discharge spaces 230. The external electrodes 250 are on an upper surface of the lamp body 240. That is, the external electrodes 250 are on an upper surface of the second substrate 220. Alternatively, auxiliary external electrodes (not shown) may be formed on a lower surface of the lamp body 240, which is a lower surface of the first substrate 210. Each of the external electrodes 250 may be electrically connected to each of the auxiliary external electrodes (not shown) through a conductive clip (not shown). Alternatively, internal electrodes (not shown) may be formed in the lamp body 240.

Each of the external electrodes 250 contains a conductive material so that the discharge voltage is applied from the inverter to the lamp body 240 through the external electrode 250. In this exemplary embodiment, a silver paste that is a mixture of silver (Ag) and silicon oxide (SiO₂) is coated on the lamp body 240 to form the external electrodes 250. Alternatively, metal powder may be coated on the lamp body 250 to form the external electrodes 250. An insulating layer (not shown) may be formed on the external electrodes 250 to protect the external electrodes 250.

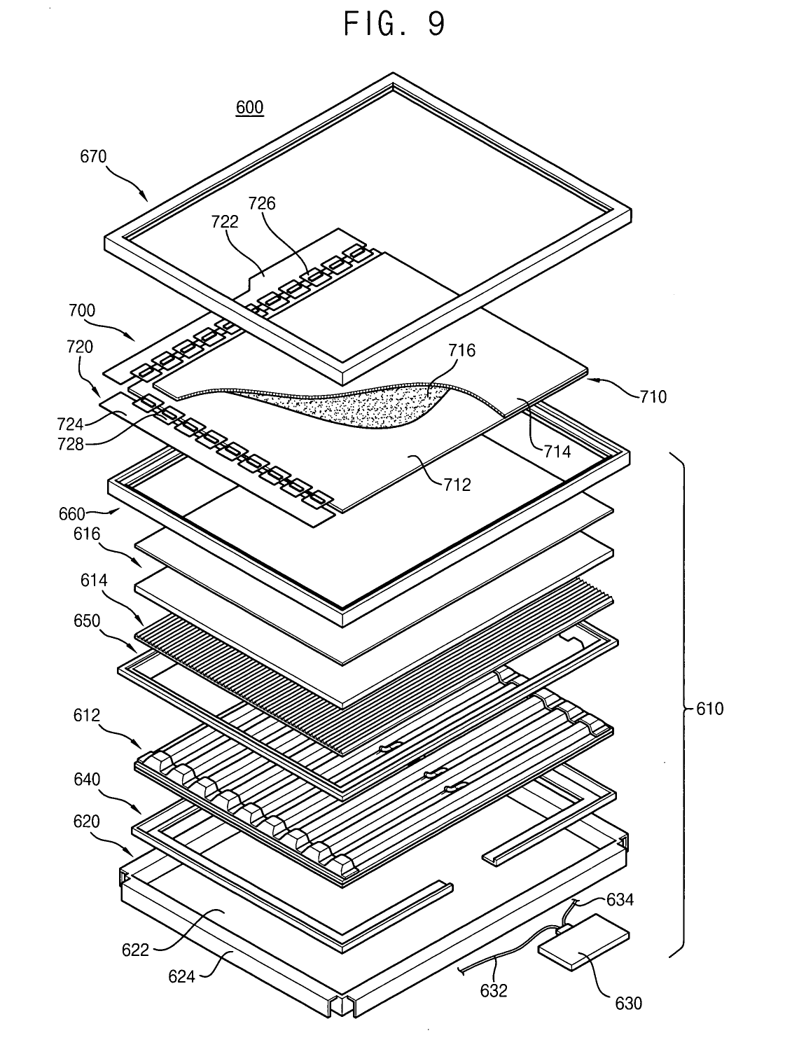

FIG. 9 is a perspective view showing an LCD device 600 in accordance with an exemplary embodiment of the present invention. A backlight assembly of the LCD device of FIG. 9 may be any of those shown in FIGS. 1 to 8. Thus, the same reference numerals will be used to refer to the same or like parts as those described in FIGS. 1 to 8 and any further explanation will be omitted.

Referring to FIG. 9, the LCD device 600 includes a backlight assembly 610 and a display unit 700.

The backlight assembly 610 includes a flat fluorescent lamp 612, a brightness enhancement member 614 and a diffusion unit 616.

The backlight assembly 610 further includes a receiving container 620 and an inverter 630. The receiving container 620 receives the flat fluorescent lamp 612. The inverter 630 applies a discharge voltage to the flat fluorescent lamp 612 to generate a visible light.

The receiving container 620 includes a bottom plate 622 and a plurality of sidewalls 624. The sidewalls 624 extend from sides of the bottom plate 622. In this exemplary embodiment, each of the sidewalls 624 is bent twice to form a combining space for combining the sidewalls 624 with other elements such as a top chassis, a frame. In this exemplary embodiment, the sidewalls 624 have an inverted U shape. The receiving container 620 is sturdy metal to securely receive the flat fluorescent lamp 200.

In this exemplary embodiment, the inverter 630 is positioned outside the receiving container 620.

The inverter 630 generates a discharge voltage to drive the flat fluorescent lamp 200. The inverter 630 elevates a level of a voltage that is provided from an exterior to the inverter 630 to drive the flat fluorescent lamp 200. The discharge voltage is applied to the flat fluorescent lamp 200 through a first power supply line 632 and a second power supply line 634.

The backlight assembly 610 may further include an insulating frame 640 interposed between the receiving container 620 and the flat fluorescent lamp 200 to support the flat fluorescent lamp 200. The insulating frame 640 is adjacent to sides of the flat fluorescent lamp 200. The flat fluorescent lamp 200 is spaced apart from the receiving container 620 by the insulating frame 640 so that the flat fluorescent lamp 200 is electrically insulated from the receiving container 620. The insulating frame 640 contains an elastic material to absorb an impact that is provided from an exterior to the LCD device 600. In this exemplary embodiment, the insulating frame 640 contains a silicone resin. For example, the insulating frame 640 may include two U-shaped pieces, four linear pieces that are adjacent to the sides of the flat fluorescent lamp 200 or four L-shaped pieces that are adjacent to corners of the flat fluorescent lamp 200. Alternatively, the insulating frame 640 may have a rectangular shape.

The backlight assembly 610 may further include a first frame 650 interposed between the flat fluorescent lamp 200 and the diffusion unit 614. The first frame 650 fixes the sides of the flat fluorescent lamp 200, and supports sides of the brightness enhancement member 614 and the diffusion unit 616. In this exemplary embodiment, the first frame 650 has a frame shape. Alternatively, the first frame 650 may include two U-shaped pieces, two L-shaped pieces corresponding to corners of the flat fluorescent lamp 200 or four linear pieces corresponding to the sides of the flat fluorescent lamp 200.

The backlight assembly 610 may further include a second frame 660 interposed between the diffusion unit 616 and the LCD panel 710. The second frame 660 fixes the sides of the brightness enhancement member 614 and the diffusion unit 616, and supports the sides of the LCD panel 710. In this exemplary embodiment, the second frame 660 has a frame shape. Alternatively, the second frame 660 may include two U-shaped pieces, two L-shaped pieces or four pieces corresponding to the sides of the flat fluorescent lamp 200.

The display unit 700 includes an LCD panel 710 and a driving circuit unit 720. The LCD panel 710 displays an image using the visible light generated from the flat fluorescent lamp 200. The driving circuit unit 720 applies driving signals to the LCD panel 710.

The LCD panel 710 includes a first substrate 712, a second substrate 714 and a liquid crystal layer 716. The second substrate 714 corresponds to the first substrate 712. The liquid crystal layer 716 is interposed between the first and second substrates 712 and 714.

The first substrate 712 is a thin film transistor (TFT) substrate having a plurality of TFTs that are arranged in a matrix shape. For example, the first substrate 712 is a glass substrate. A source electrode of each of the TFTs is electrically connected to a data line. A gate electrode of each of the TFTs is electrically connected to a gate line. A drain electrode of each of the TFTs is electrically connected to a pixel electrode that contains transparent conductive material.

The second substrate 714 is a color filter substrate. For example, the second substrate 714 is a glass substrate. The second substrate 714 has a common electrode (not shown) that contains a transparent conductive material.

When an electric power is applied to the gate electrode of each of the TFTs so that the TFT is turned on, an electric field is formed between the pixel electrode (not shown) and the common electrode (not shown). Therefore, an arrangement of the liquid crystal layer 716 between the first and second substrates 712 and 714 is changed by the electric field applied to the liquid crystal layer 716 so that a light transmittance of the liquid crystal layer 716 is changed to display the image having a predetermined gray-scale.

The driving circuit unit 720 includes a data printed circuit board (PCB) 722, a gate PCB 724, a data flexible circuit film 726 and a gate flexible film 728. The data PCB 722 applies a data driving signal to the LCD panel 710. The gate PCB 724 applies a gate driving signal to the LCD panel 710. The data flexible circuit film 726 electrically connects the data PCB 722 to the LCD panel 710. The gate flexible circuit film 728 electrically connects the gate PCB 724 to the LCD panel 710. Each of the data and gate flexible circuit films 726 and 728 may be a tape carrier package (TCP) or a chip on film (COF). Alternatively, the LCD panel 710 and the gate flexible circuit film 728 may include additional signal transmission lines so that the gate PCB 724 may be omitted.

The LCD device 600 may further include a top chassis 670 to secure the display unit 700. The top chassis 670 is combined with the receiving container 620 to secure the sides of the LCD panel 710. The data PCB 722 is bent by the data flexible circuit film 726 to be fixed on the sidewalls or the bottom plate of the receiving container 620. The top chassis 670 may have a strong metal.

According to the present invention, the brightness enhancement member is interposed between the flat fluorescent lamp and the diffusion unit to provide uniform luminance, and to reduce the thickness of the backlight assembly.

In addition, the diffusion plate may be omitted, and the diffusion unit may only include a diffusion sheet to reduce the thickness of the backlight assembly and increase the luminance of the viewer's side.

This invention has been described with reference to the exemplary embodiments. It is evident, however, that many alternative modifications and variations will be apparent to those having skill in the art in light of the foregoing description. Accordingly, the present invention embraces all such alternative modifications and variations as fall within the spirit and scope of the appended claims.

What is claimed is:

1. A backlight assembly comprising:
a flat fluorescent lamp having a plurality of discharge spaces to generate light;
a brightness enhancement member supported in operative relationships with the flat fluorescent lamp; and
a light diffusing member positioned on the brightness enhancement member.

2. The backlight assembly of claim 1, wherein the brightness enhancement member comprises a prism pattern having a plurality of triangular-shaped prism members that are adjacent to one another.

3. The backlight assembly of claim 2, wherein the brightness enhancement member further comprises a transparent film, and the prism pattern is formed on the transparent film.

4. The backlight assembly of claim 2, wherein the brightness enhancement member further comprises a transparent plate, and the prism pattern is formed on the transparent plate.

5. The backlight assembly of claim 2, wherein an interior angle of adjacent sides of walls of the prism members ranges from about 600° to about 120°.

6. The backlight assembly of claim 2, wherein a pitch between adjacent prisms is from about 10 μm to about 100 μm.

7. The backlight assembly of claim 5, wherein a pitch between adjacent prisms is from about 10 μm to about 100 μm.

8. The backlight assembly of claim 5, wherein a surface of the flat fluorescent lamp is spaced apart from a surface of the brightness enhancement member by a distance of from about 1 mm to about 10 mm.

9. The backlight assembly of claim 2, wherein an interior angle of adjacent sides of walls of the prism members is about 90°, and a pitch between adjacent prisms is about 50 μm.

10. The backlight assembly of claim 9, wherein the flat fluorescent lamp is spaced apart from the brightness enhancement member by a distance of about 3 mm to about 4 mm.

11. The backlight assembly of claim 2, wherein an interior angle of adjacent sides of walls of the prism members is about 68°, and a pitch between adjacent prisms is about 50 μm.

12. The backlight assembly of claim 11, wherein the flat fluorescent lamp is spaced apart from the brightness enhancement member by a distance of about 3 mm to about 4 mm.

13. The backlight assembly of claim 2, wherein a peak of each of the prisms is rounded.

14. The backlight assembly of claim 2, wherein the flat fluorescent lamp comprises:
a lamp body having a plurality of discharge spaces that are spaced apart from one another; and
an electrode on an end portion of the lamp body, the electrode crossing the discharge spaces.

15. The backlight assembly of claim 14, wherein the lamp body comprises:
a first substrate; and
a second substrate combined with the first substrate to form the discharge spaces, the second substrate including:
a plurality of discharge space portions spaced apart from the first substrate;
a plurality of space dividing portions between the discharge space portions, the space dividing portions making contact with the first substrate; and
a sealing portion that surrounds the discharge space portions and the space dividing portions, the sealing portion making contact with a peripheral portion of the first substrate.

16. The backlight assembly of claim 15, wherein the backlight assembly includes a plurality of prism patterns, and at least some of the space dividing portions have an associated prism pattern.

17. The backlight assembly of claim 1, wherein the light diffusing member comprises a diffusion plate.

18. The backlight assembly of claim 17, wherein the diffusion member further comprises at least one diffusion sheet on the diffusion plate.

19. The backlight assembly of claim 1, wherein the diffusion member comprises at least one diffusion sheet.

20. A liquid crystal display device comprising:
a backlight assembly including:
a flat fluorescent lamp having a plurality of discharge spaces to generate light;
a brightness enhancement member supported in operative relationships with the flat fluorescent lamp; and
a diffusion member on the brightness enhancement member, the diffusion member diffusing the guided light; and
a liquid crystal display panel on the diffusion member.

21. The liquid crystal display device of claim 20, wherein the brightness enhancement member comprises a prism pattern having a plurality of triangular-shaped prism members that are adjacent to one another.

22. The liquid crystal display device of claim 21, wherein an interior angle of adjacent sides of walls of the prism members ranges from about 60° to about 120 and a pitch between adjacent prisms is about 10 μm to about 100 μm.

23. The liquid crystal display device of claim 21, wherein a pitch between adjacent prisms is from about 10 μm to about 100 μm.

24. The liquid crystal display device of claim 22, wherein a pitch between adjacent prisms is from about 10 μm to about 100 μm.

25. The liquid crystal display device of claim 20, wherein the flat fluorescent lamp is spaced apart from the brightness enhancement member by a distance of about 1 mm to about 10 mm.

26. The liquid crystal display device of claim 20, wherein the diffusion member further comprises at least one diffusion sheet on the diffusion plate.

27. The liquid crystal display device of claim 20, wherein the backlight assembly further comprises:
a receiving container adapted to support the flat fluorescent lamp; and
an inverter that applies a discharge voltage to the flat fluorescent lamp to generate the light.

28. The liquid crystal display device of claim 27, wherein the backlight assembly further comprises:
an insulating member interposed between the flat fluorescent lamp and the receiving container, the insulating member supporting the flat fluorescent lamp;
a first frame interposed between the flat fluorescent lamp and the brightness enhancement member, the first frame fixing the flat fluorescent lamp; and
a second frame interposed between the diffusion member and the liquid crystal display panel, the second frame securing the brightness enhancement member and the diffusion member.
